(19) United States
(12) Patent Application Publication
(10) Pub. No.: US 2002/0101630 A1
(43) Pub. Date: Aug. 1, 2002

(54) Monitor, control and configuration of fiber node via cable modem

(75) Inventor: Paul E. Nikolich, Lynnfield, MA (US)

Correspondence Address: Fogg, Slifer & Polglaze, P.A., P. O. Box 581009, Minneapolis, MN, 55458-1009, US

(73) Assignee: ADC Telecommunications, Inc.

(21) Appl. No.: 09/775,224

(22) Filed: Feb. 1, 2001

(51) Int. Cl. H04B 10/08; H04J 14/02

(52) U.S. Cl. 359/110; 359/125

(57) ABSTRACT

Embodiments of the present invention provide a hybrid fiber-coax network having a head end and at least one fiber node in two-way communication therewith. A cable modem is located within the fiber node that provides a communication channel. The communication channel is adapted to transmit at least one informational signal that is indicative of a condition of the fiber node to the head end and is adapted to receive at least one control signal from the head end.

### TECHNICAL FIELD

The present invention relates generally to the field of cable networks and, in particular, to the control of fiber nodes of hybrid fiber-coax networks.

### BACKGROUND

Hybrid fiber-coax networks are used to disseminate a variety of signals. For example, cable television operators typically use hybrid fiber-coax networks to transmit television signals to subscribers. Hybrid fiber-coax networks are often used to transmit other signals to subscribers and receive other signals from subscribers, e.g., a hybrid fiber-coax network may be connected to a data network, such as the Internet, and used to transmit data signals from the data network to subscribers and used to transmit data signals received from subscribers to the data network. Some hybrid fiber-coax networks transmit television signals to users and transmit data between subscribers and data networks.

Hybrid fiber-coax networks typically include a head end that functions as a distribution hub for the various signals. The head end typically includes receiving equipment for television signals and circuitry that interfaces with a data network, e.g., a cable modem transmission system (CMTS). Hybrid fiber-coax networks include fiber nodes that terminate runs of fiber cables emanating from the head end and that facilitate the dissemination of the various signals to neighborhoods of subscribers.

Fiber nodes are communicatively coupled to the head end over the fiber optic cable. Fiber nodes are also communicatively coupled to various subscriber equipment, e.g., cable modems, televisions, set top boxes, VCRs, telephones, and the like, over coaxial cables. Fiber nodes include a variety of equipment. Some existing hybrid fiber-coax networks allow the fiber nodes to be monitored and controlled from the head end. For example, it may be desirable to monitor the temperature of the fiber node from the head end and to adjust the operation of the node as necessary from the head end. Conventionally, establishing two-way communication between fiber-node equipment and the head end has been accomplished by proprietary protocols that vary from vendor to vendor, are burdensome to develop and maintain, and are low-speed (e.g., less than 100 kbps).

For the reasons stated above, and for other reasons stated below which will become apparent to those skilled in the art upon reading and understanding the present specification, there is a need in the art for hybrid fiber-coax networks with a more economical and less burdensome method for monitoring and controlling a fiber node.

### SUMMARY

The above-mentioned problems with monitoring and controlling equipment within a fiber node of a hybrid fiber-coax network from the head end of the network and the communication between the equipment and the head end that facilitates the monitor and control and other problems are addressed by embodiments of the present invention and will be understood by reading and studying the following specification. Embodiments of the present invention provide a hybrid fiber-coax network.

More particularly, in one embodiment the hybrid fiber-coax network has a head end and at least one fiber node in two-way communication therewith. A standards-based cable modem is located within the fiber node. The cable modem provides a communication channel. The communication channel is adapted to transmit at least one informational signal that is indicative of a condition of the fiber node to the head end and is adapted to receive at least one control signal from the head end.

### BRIEF DESCRIPTION OF THE DRAWINGS

FIG. 1 is a diagram demonstrating a first embodiment of the present invention.

FIG. 2 is a diagram demonstrating a second embodiment of the present invention.

FIG. 3 is a flow chart of the problem-identification operating mode of the second embodiment.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention involve locating a cable modem utilizing the standards-based DOCSIS protocol in at least one fiber node of a hybrid fiber-coax network and using the cable modem to establish two-way communication between the fiber node and the head end of the network. Using a cable modem in this way is a simple, inexpensive alternative to the proprietary protocols used by some cable operators to establish two-way communication between the head end and the fiber node. For example, the readily available, relatively inexpensive data-over-cable service-interface-specification (DOCSIS) cable-modem can be used to establish the two-way communication. Two-way communication between the head end and the fiber node enables cable operators to monitor and control the fiber node from the head end. For example, monitor and control of the fiber node will enable cable operators to identify and alleviate many problems from the head end without having to dispatch technicians, thereby reducing costs and downtime.

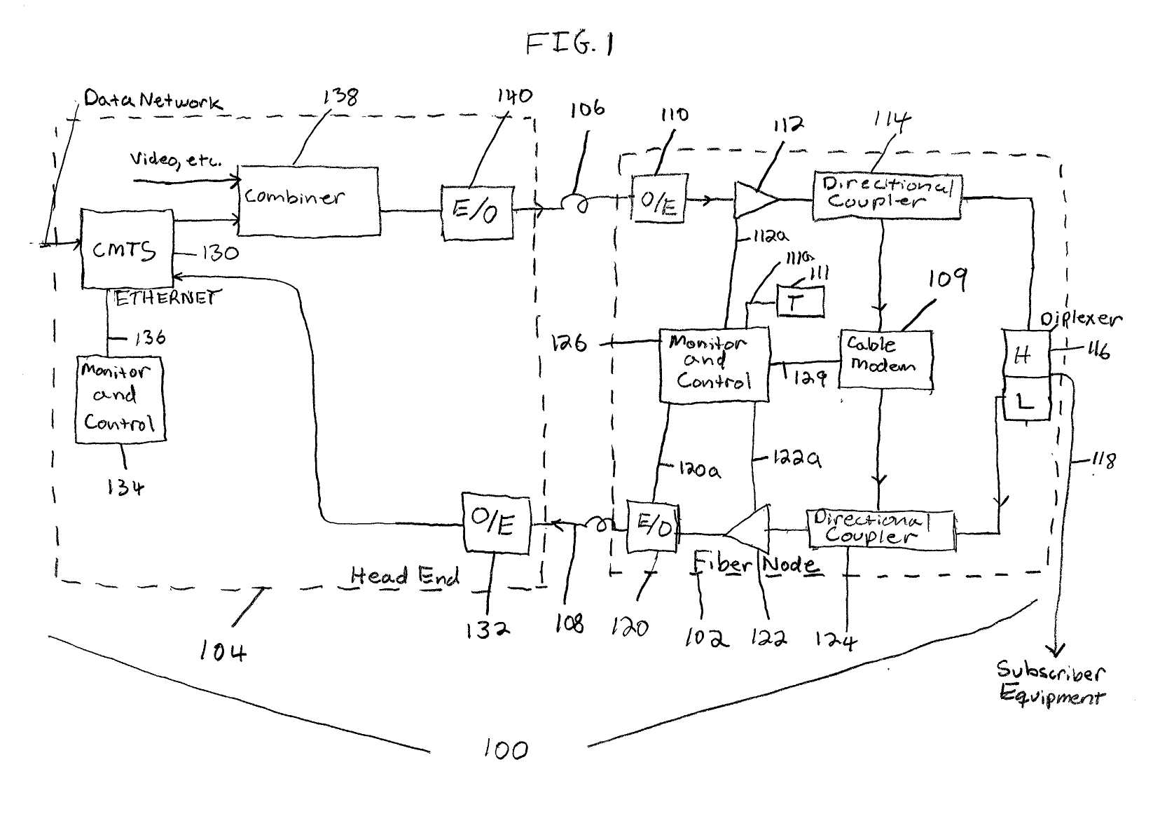

Hybrid fiber-coax network 100, shown in FIG. 1, demonstrates a first embodiment of the present invention. Network 100 has at least one fiber node 102 and head end 104. Fiber node 102 is in two-way communication with head end 104 via lines 106 and 108. Lines 106 and 108 comprise one or more fiber optic cables that couple head end 104 and fiber node 102. Fiber node 102 includes cable modem 109, e.g., a data-over-cable service-interface-specification (DOCSIS) cable-modem. Cable modem 109 provides a communication channel adapted to transmit at least one informational signal that is indicative of at least one condition of fiber node 102 to head end 104 and that is adapted to receive at least one control signal from head end 104, where the condition of fiber node 102 is any appropriate condition that impacts the ability of network 100 to transmit and receive signals from the cable subscribers.

Fiber node 102 receives a stream of signals from head end 104 via line 106 and transmits a stream of signals to the head end via line 108. In one embodiment, line 106 carries downstream signals in the range of 54 to 870 MHz, and line 108 carries signals in the range of 5 to 42 MHz. In other embodiments, other appropriate frequency ranges are used, e.g., upstream signals in the 5 to 65 MHz range.

Fiber node 102 has optical-to-electrical converter 110 that receives the stream of signals from head end 104 via line 106. Fiber node 102 includes amplifier 112 that is coupled to optical-to-electrical converter 110. Amplifier 112 is coupled to directional coupler 114. Directional coupler 114 is coupled to an input for cable modem 109. Directional coupler 114 is also coupled to pass signals to diplexer 116. Diplexer 116 is adapted to transmit the stream of signals from head end 104 to users via input-output line 118.

Fiber node 102 has electrical-to-optical converter 120 that transmits the stream of signals to the head end via line 108. Fiber node 102 has amplifier 122 that is coupled to electrical-to-optical converter 120. Amplifier 122 is also coupled to directional coupler 124. Directional coupler 124 is coupled to an output of cable modem 109. Directional coupler 124 is also coupled to receive signals from diplexer 116. Diplexer 116 is also adapted to receive the stream of signals that is transmitted to the head end from users via input-output line 118.

At least one of optical-to-electrical converter 110, electrical-to-optical converter 120, or amplifiers 112 or 122 is a controllable device that has at least one controllable condition determined by the operation thereof, where a controllable condition is any appropriate condition that impacts the ability of network 100 to transmit and receive signals from the cable subscribers. For example, in one embodiment the gain of either or both of amplifiers 112 and 122 is controllable. In another embodiment, the power output, output amplitude, and/or the receive sensitivity of either or both optical-to-electrical converter 110 and electrical-to-optical converter 120 are/is controllable. In another embodiment, the gain of either or both of amplifiers 112 and 122 is controllable and the power output, output amplitude, and/or the receive sensitivity of either or both optical-to-electrical converter 110 and electrical-to-optical converter 120 are/is controllable.

Fiber node 102 includes monitor and control circuit 126 that is coupled to optical-to-electrical converter 110, electrical-to-optical converter 120, and amplifiers 112 and 122 via input-output lines 11Oa, 120a, 112a, and 122a, respectively. Monitor and control circuit 126 is also coupled to temperature sensor 111. In another embodiment, monitor and control circuit 126 is coupled to at least one of optical-to-electrical converter 110, temperature sensor 111, electrical-to-optical converter 120, or amplifiers 112 or 122. Monitor and control circuit 126 receives at least one informational signal from at least one of optical-to-electrical converter 110, temperature sensor 111, electrical-to-optical converter 120, or amplifiers 112 or 122 via at least one of the respective input-output lines 11Oa, 111a, 120a, 112a, or 122a, the informational signal being indicative of at least one condition thereof, where a condition is any appropriate condition that impacts the ability of network 100 to transmit and receive signals from the cable subscribers.

Cable modem 109 is coupled to monitor and control circuit 126 via input-output line 129 and receives the informational signal from monitor and control circuit 126. Cable modem 109 is coupled to directional couplers 114 and 124. Cable modem 109 transmits the informational signal to directional coupler 124, which injects the informational signal into the stream of signals from the users.

Network 100 has cable modem transmission system 130 located at head end 104 that is coupled to optical-to-electrical converter 132. Optical-to-electrical converter 132 is coupled to electrical-to-optical converter 120 via line 108 that carries the informational signal and the stream of signals from the users. Network 100 includes monitor and control subsystem 134 located at head end 104 that is coupled to cable modem transmission system 130 via input-output line 136. Input-output line 136 is connected to cable modem transmission system 130 using an interface of the type used for ETHERNET connections. The informational signal is transmitted to monitor and control subsystem 134 from cable modem transmission system 130 via input-output line 136.

Monitor and control subsystem 134 evaluates the informational signal. For example, monitor and control subsystem 134 compares the informational signal to a preselected value indicative of an acceptable level for at least one of the controllable conditions of at least one of the controllable devices. If the comparison indicates that the informational signal is at an unacceptable level relative to the preselected value, monitor and control subsystem 134 transmits a control signal to cable modem transmission system 130 via input-output line 136 to alter the operation of the controllable device.

In other embodiments, monitor and control subsystem 134 determines whether any changes need to be made based on the received informational signal. For example, monitor and control subsystem 134 receives an informational signal from temperature sensor 111 indicative of the temperature of fiber node 102 and determines to alter the operation of amplifier 112 to change its gain based on the informational signal. Monitor and control subsystem 134 transmits a control signal that changes the gain of amplifier 112 based on the informational signal from temperature sensor 111.

Cable modem transmission system 130 is coupled to combiner 138 that is coupled to electrical-to-optical converter 140. Electrical-to-optical converter 140 is coupled to line 106. Cable modem transmission system 130 is also coupled to a data network and receives data signals therefrom. Cable modem transmission system 130 transmits the control signal and the data signal to combiner 138 that combines the control signal and the data signal with other signals, e.g., a video signal. In one embodiment cable modem transmission system 130 is not coupled to a data network, and it transmits the control signal only to combiner 138.

The control signal and other signals are transmitted from head end 104 to directional coupler 114, where the signal is tapped off and to sent to cable modem 109. Cable modem 109 transmits the control signal to monitor and control circuit 126 via input-output line 129. Monitor and control circuit 126 transmits the control signal to at least one of the controllable devices via the respective input-output line.

In operation, at least one informational signal is received by cable modem 109 that is indicative of at least one controllable condition of fiber node 102. Cable modem 109 transmits the informational signal to head end 104. The informational signal is evaluated at head end 104. For example, the informational signal is compared to a preselected value indicative of acceptable level for the controllable condition. If the comparison indicates that the informational signal is at an unacceptable level relative to the preselected value, head end 104 transmits a control signal to cable modem 109 to alter the operation of fiber node 102. In other embodiments, the evaluation determines whether any changes need to be made based on the received informational signal.

More specifically, the informational signal is transmitted from at least one controllable device (optical-to-electrical converter 110, temperature sensor 111, electrical-to-optical converter 120, or amplifiers 112 or 122) to monitor and control circuit 126 via at least one of the respective input-output lines 110a, 111a, 120a, 112a, and 122a, the informational signal being indicative of at least one controllable condition thereof. The informational signal is transmitted from monitor and control circuit 126 to cable modem 109 via input-output line 129. The informational signal is transmitted from cable modem 109 to cable modem transmission system 130 via directional coupler 124, amplifier 122, electrical-to-optical converter 120, line 108, and optical-to-electrical converter 132. The informational signal is transmitted from cable modem transmission system 130 via input-output line 136 to monitor and control subsystem 134, where it is evaluated.

In other embodiments, monitor and control subsystem 134 determines whether any changes need to be made based on the received informational signal. For example, monitor and control subsystem 134 receives an informational signal from temperature sensor 111 indicative of the temperature of fiber node 102 and determines to alter the operation of amplifier 112 to change its gain based on the informational signal. Monitor and control subsystem 134 transmits a control signal that changes the gain of amplifier 112 based on the informational signal from temperature sensor 111.

The control signal is transmitted from cable modem transmission system 130 to cable modem 109 via combiner 138, electrical-to-optical converter 140, line 106, optical-to-electrical converter 110, amplifier 112, and directional coupler 114. The control signal is transmitted from cable modem 109 to monitor-and-control circuit 126 via input-output line 129. The control signal is transmitted to at least one controllable device via the respective input-output line to alter its operation.

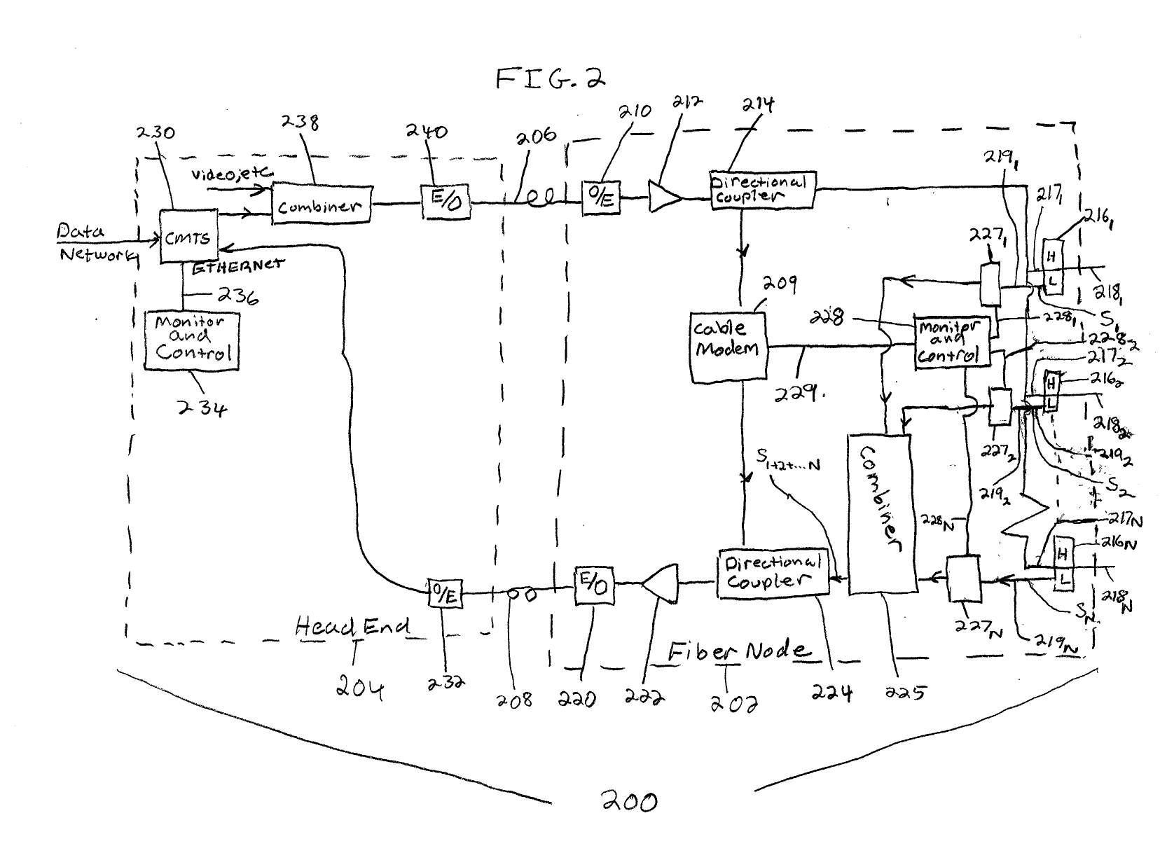

Hybrid fiber-coax network 200, shown in FIG. 2, demonstrates a second embodiment of the present invention. Network 200 has at least one fiber node 202 and head end 204. Fiber node 202 is in two-way communication with head end 204 via lines 206 and 208. Lines 206 and 208 comprise one or more fiber optic cables that couple head end 204 and fiber node 202. Fiber node 202 includes cable modem 209, e.g., a data-over-cable service-interface-specification (DOCSIS) cable-modem. Cable modem 209 provides a communication channel adapted to transmit at least one informational signal that is indicative of a condition of fiber node 202 to head end 204 and that is adapted to receive at least one control signal from head end 204, where the condition of fiber node 202 is any appropriate condition that impacts the ability of network 200 to transmit and receive signals from the cable subscribers.

Fiber node 202 receives a stream of signals from head end 204 via line 206 and transmits a stream of signals to the head end via line 208. In one embodiment, line 206 carries downstream signals in the range of 54 to 870 MHz, and line 208 carries signals in the range of 5 to 42 MHz. In other embodiments, other appropriate frequency ranges are used, e.g., upstream signals in the 5 to 65 MHz range.

Fiber node 202 has optical-to-electrical converter 210 that receives the stream of signals from head end 204 via line 206. Fiber node 202 includes amplifier 212 that is coupled to optical-to-electrical converter 210. Amplifier 212 is coupled to directional coupler 214. Directional coupler 214 is coupled to an input of cable modem 209. Directional coupler 214 is also coupled to pass signals to each of diplexers 216₁ to 216_{N} via lines 217₁ to 217_{N}, respectively. Each of diplexers 216₁, to 216_{N} is adapted to respectively transmit the stream of signals received from the head end to users via input-output lines 218₁ to 218_{N}. These signals are respectively transmitted over a downstream line of each of input-output lines 218₁ to 218_{N}.

Fiber node 202 has electrical-to-optical converter 220 that transmits the stream signals to the head end via line 208. Fiber node 202 has amplifier 222 that is coupled to electrical-to-optical converter 220. Amplifier 222 is also coupled to directional coupler 224. Directional coupler 224 is coupled to an output of combiner 225. Inputs of combiner 225 are respectively coupled to each of switches 227₁, to 227_{N}.

Switches 227₁ to 227_{N} are coupled to of each of diplexers 216₁ to 216_{N}, respectively, by each of lines 219₁ to 219_{N}, respectively. Diplexers 216₁ to 216_{N} are adapted to respectively transmit the stream of signals received from users via input-output lines 218₁ to 218_{N} in the upstream frequency band, e.g., 5-to-42 MHz band. These signals are received from the users over an upstream line of input-output lines 218₁ to 218_{N}.

Fiber node 202 includes monitor and control circuit 228 that is coupled to each of switches 227₁ to 227_{N} via input-output lines 228₁ to 228_{N}, respectively. Cable modem 209 is coupled to monitor and control circuit 228 via input-output line 229. An input and output of cable modem 209 are respectively coupled to directional couplers 214 and 224.

Network 200 has cable modem transmission system 230 located at head end 204 that is coupled to optical-to-electrical converter 232. Optical-to-electrical converter 232 is coupled to electrical-to-optical converter 220 via line 208. Network 200 includes monitor and control subsystem 234 located at head end 204 that is coupled to cable modem transmission system 230 via input-output line 236. Input-output line 236 is connected to cable modem transmission system 230 using an interface of the type used for ETHERNET connections.

Cable modem transmission system 230 is coupled to combiner 238 that is coupled to electrical-to-optical converter 240. Electrical-to-optical converter 240 is coupled to line 206. Cable modem transmission system 230 is also coupled to a data network and receives data signals therefrom. Combiner 238 also receives other signals, e.g., video signals, and combines them with data signals. In one embodiment cable modem transmission system 230 is not coupled to a data network.

Operation of hybrid fiber-coax network 200 comprises a normal operation mode and a problem identification mode. The problem identification mode identifies at least one problematic upstream line of input-output lines 218₁ to 218_{N}. Note that a signal is received at each of switches 227₁ to 227_{N} from the upstream lines of input-output lines 218₁ to 218_{N}, respectively. Each of these signals will be referred to as an upstream signal in the ensuing discussion.

In the normal operation mode, an upstream signal from an upstream line of each of input-output lines 218₁ to 218_{N} is transmitted to one of diplexers 216₁ to 216_{N}, respectively, in the upstream frequency band, e.g., 5-to-42-MHz band. The respective upstream signals are transmitted as signals S₁ to S_{N} to switches 227₁ to 227_{N}, respectively. The respective switches transmit the upstream signals to combiner 225 that combines these signals to form combined signal S_{1+2+. . . N}.

Combiner 225 transmits combined signal S_{1+2+. . . N} to monitor and control subsystem 234 via directional coupler 224, electrical-to-optical converter 220, line 208, optical-to-electrical converter 232, cable modem transmission system 230, and input-output line 236. Monitor and control subsystem 234 evaluates combined signal S_{1+2+. . . N} by comparing it to at least one preselected value indicative of an acceptable level for at least one performance parameter of the combined upstream signal, e.g., the signal-to-noise ratio of the combined upstream signal. If the comparison indicates that the level of at least one performance parameter of combined signal S_{1+2+. . . N} is at an unacceptable level relative to the preselected value, an indication of a problem in the upstream line of at least one of input-output lines 218₁ to 218_{N}, the problem identification mode is initiated.

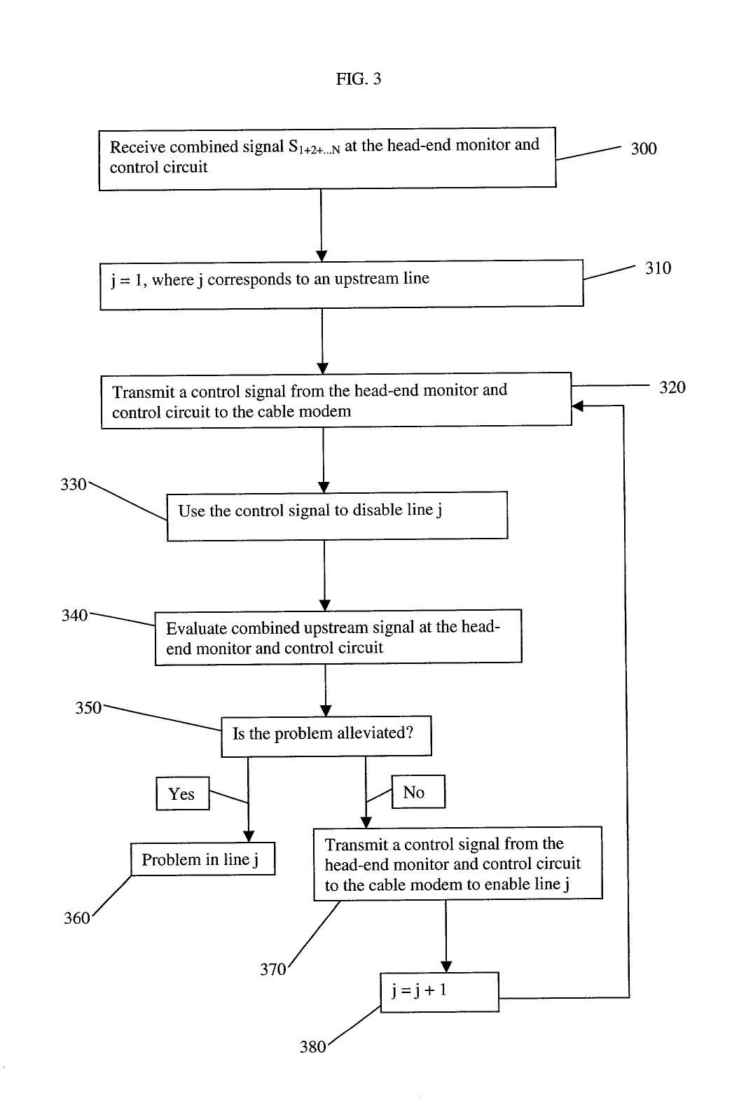

The problem identification mode is demonstrated by the flowchart of FIG. 3. The problem identification mode demonstrated in FIG. 3 commences at block 300 with receiving combined upstream signal S_{1+2+. . . N} at monitor and control subsystem 234, indicating a problem in the upstream line of at least one of input-output lines 218₁ to 218_{N}. In one embodiment, the problem identification mode includes monitor and control subsystem 234 evaluating combined signal S_{1+2+. . . N} and determining that a problem in the upstream line of at least one of input-output lines 218₁ to 218_{N} exists.

At block 310, monitor and control subsystem 234 selects line 219₁ to be disabled. At block 320, monitor and control subsystem 234 transmits a control signal to cable modem transmission system 230 via input-output line 236. Cable modem transmission system 230 transmits the control signal to cable modem 209 via combiner 238, electrical-to-optical converter 240, line 206, optical-to-electrical converter 210, amplifier 212, and directional coupler 214. The control signal is transmitted to monitor and control circuit 228 via input-output line 229. At block 330, monitor and control circuit 228 transmits the control signal to switch 227, to disable line 219₁, preventing corresponding upstream signal S₁ from being combined with the remaining upstream signals.

At block 340, monitor and control subsystem 234 evaluates combined upstream signal S_{1+2+. . . N} less upstream signal S₁ as described above. At block 350, monitor and control subsystem 234 determines if the problem is alleviated based on the evaluation. If an acceptable level is indicated, monitor and control subsystem 234 identifies the upstream line of input-output line 218₁, as the problematic line at block 360. If the level is still unacceptable, monitor and control subsystem 234 transmits a control signal at block 370 to switch 227₁, to enable line 219₁, allowing corresponding upstream signal S₁ to be combined with the remaining upstream signals. At block 380, monitor and control subsystem 234 selects line 219₂ to be disabled, and the process is repeated for each of switches 227₁ to 227_{N} until the problematic upstream line is identified, as demonstrated in the flowchart in FIG. 3. In one embodiment, after the problematic upstream line is identified, a control signal is transmitted from monitor and control subsystem 234 to the problematic line via cable modem 209 that alleviates the problem.

### Conclusion

Embodiments of the present invention have been described. The embodiments provide a hybrid fiber-coax network having a head end and at least one fiber node that has a cable modem, where the cable modem enables monitor and control of the fiber node by the head end.

Although specific embodiments have been illustrated and described in this specification, it will be appreciated by those of ordinary skill in the art that any arrangement that is calculated to achieve the same purpose may be substituted for the specific embodiment shown. This application is intended to cover any adaptations or variations of the present invention. For example, an amplifier may be placed between combiner 225 and each of switches 227₁ to 227_{N}.

what is claimed is:

1. A hybrid fiber-coax network comprising:
a head end;
at least one fiber node in two-way communication with the head end; and
a cable modem located within the fiber node, wherein the cable modem provides a communication channel adapted to transmit at least one informational signal that is indicative of a condition of the fiber node to the head end and that is adapted to receive at least one control signal from the head end.

2. The network of claim 1, wherein the cable-modem is a data-over-cable service-interface-specification cable-modem.

3. The network of claim 1, and further including a monitor-and-control circuit that is coupled to the cable-modem.

4. The network of claim 3, and further including at least one controllable device located within the fiber node that is coupled to the monitor-and-control circuit.

5. The network of claim 1, and further including a cable modem transmission system that communicates with the cable modem.

6. The network of claim 1, and further including a monitor-and-control subsystem in the head end that communicates with the cable-modem through a cable modem transmission system.

7. A hybrid fiber-coax network comprising:
at least one fiber node including at least one controllable device;
a monitor-and-control circuit located within the fiber node that is adapted to receive at least one informational signal from the controllable device indicative of a condition of the controllable device, that is adapted to transmit the informational signal, that is adapted to receive at least one control signal, and that is adapted to transmit the control signal to the controllable device to alter the condition of the controllable device;
a cable modem located within the fiber node, wherein the cable modem provides a communication channel that is adapted to receive the informational signal from the monitor-and-control circuit, that is adapted to transmit the informational signal, that is adapted to receive the control signal, and that is adapted to transmit the control signal to the monitor-and-control circuit;
a head end;
a cable modem transmission system at the head end that is adapted to receive the informational signal from the cable modem, that is adapted to transmit the informational signal, that is adapted receive the control signal, and that is adapted transmit the control signal to the cable modem; and
a monitor-and-control subsystem at the head end that is adapted to receive the informational signal transmitted by the cable modem transmission system, that is adapted to evaluate the informational signal, and that is adapted to transmit the control signal, based on the evaluation, to the cable modem transmission system.

8. The network of claim 7, wherein the monitor-and-control circuit includes at least one port coupled to the controllable device that is adapted to receive the informational signal and to transmit the control signal and wherein the monitor-and-control circuit includes a port coupled to the cable-modem communication channel that is adapted to transmit the informational signal and to receive the control signal.

9. The network of claim 7, wherein the cable-modem includes a first port coupled to the cable-modem communication channel and coupled to the monitor-and-control circuit that is adapted to receive the informational signal and to transmit the control signal, wherein the cable-modem includes a second port coupled to the cable-modem communication channel and coupled to the cable modem transmission system that is adapted to transmit the informational signal, and wherein the cable-modem includes a third port coupled to the cable-modem communication channel and coupled to the cable modem transmission system that is adapted to receive the control signal.

10. The network of claim 7, wherein the cable modem transmission system includes a first port coupled to the cable-modem communication channel that is adapted to receive the informational signal, wherein the cable modem transmission system includes a second port coupled to the cable-modem communication channel that is adapted to transmit the control signal, and wherein the cable modem transmission system includes a third port coupled to the monitor-and-control subsystem that is adapted to transmit the informational signal and to receive the control signal.

11. The network of claim 7, wherein the monitor-and-control subsystem includes a port coupled to the cable modem transmission system that is adapted to receive the informational signal and to transmit the control signal.

12. The network of claim 7, wherein the controllable device includes at least any one of an amplifier, an optical-to-electrical converter, an electrical-to-optical converter, a temperature sensor, or an output line of the fiber node.

13. A hybrid fiber-coax network comprising:
at least one fiber node including at least one controllable device;
a monitor-and-control circuit located within the fiber node, the monitor-and-control circuit having at least one first input-output and a second input-output, wherein the first input-output of the monitor-and-control circuit receives an informational signal from the controllable device that is indicative of a condition of the controllable device;
a cable modem located within the fiber node, the cable modem having an input, output, and input-output, wherein the cable-modem input-output receives the informational signal from the second input-output of the monitor-and-control circuit;
a head end;
a cable modem transmission system at the head end that has an input that receives the informational signal from the output of the cable modem, the cable modem transmission system having an output and an input-output; and
a monitor-and-control subsystem at the head end that has an input-output, the monitor-and-control subsystem input-output receiving the informational signal from the input-output of the cable modem transmission system, wherein the monitor-and-control subsystem evaluates the informational signal, whereby evaluating the condition of the controllable device, and transmits at least one control signal based on the evaluation through its input-output to the input-output of the cable modem transmission system, wherein the control signal is transmitted from the output of the cable modem transmission system to the input of the cable modem, wherein the control signal is transmitted to the second input-output of the fiber-node monitor-and-control circuit, wherein the first input-output of the monitor-and-control circuit transmits the control signal to the controllable device to alter its operation based on the evaluation of the monitor-and-control subsystem.

14. A fiber node comprising:
at least one input line and at least one output line;
at least one controllable device;
a monitor-and-control circuit that is adapted to receive at least one informational signal from the controllable device indicative of a condition of the controllable device, that is adapted to transmit the informational signal, that is adapted to receive at least one control signal, and that is adapted to transmit the control signal to the controllable device to alter the condition of the controllable device; and
a cable modem, wherein the cable modem provides a communication channel that is adapted to receive the informational signal from the monitor-and-control circuit, that is adapted to transmit the informational signal to the output line, that is adapted to receive the control signal from the input line, and that is adapted to transmit the control signal to the monitor-and-control circuit.

15. The fiber node of claim 14, wherein the monitor-and-control circuit includes at least one port coupled to the controllable device that is adapted to receive the informational signal and to transmit the control signal and wherein the monitor-and-control circuit includes a port coupled to the cable-modem communication channel that is adapted to transmit the informational signal and to receive the control signal.

16. The fiber node of claim 14, wherein the cable-modem includes a first port coupled to the cable-modem communication channel and coupled to the monitor-and-control circuit that is adapted to receive the informational signal and to transmit the control signal, wherein the cable-modem includes a second port coupled to the cable-modem communication channel and coupled to the output line that is adapted to transmit the informational signal to the output line, and wherein the cable-modem includes a third port coupled to the cable-modem communication channel and coupled to the input line that is adapted to receive the control signal from the input line.

17. The fiber node of claim 14, wherein the controllable device includes at least any one of an amplifier, an optical-to-electrical converter, an electrical-to-optical converter, a temperature sensor, or an output line of the fiber node.

18. A fiber node comprising:
at least one input line and at least one output line;
at least one controllable device;
a monitor-and-control circuit, wherein the monitor-and-control circuit includes at least one first port coupled to the controllable device that is adapted to receive at least one informational signal from the controllable device indicative of a condition of the controllable device and to transmit at least one control signal to the controllable device to alter the operation of the controllable device and wherein the monitor-and-control circuit includes a second port that is adapted to transmit the informational signal and to receive the control signal; and
a cable modem, wherein the cable modem provides a communication channel, wherein the cable-modem includes a first port coupled to the communication channel and coupled to the second port of the monitor-and-control circuit that is adapted to receive the informational signal from the monitor-and-control circuit and to transmit the control signal to the monitor-and-control circuit, wherein the cable-modem includes a second port coupled to the communication channel and coupled to the output line that is adapted to transmit the informational signal to the output line, and wherein the cable-modem includes a third port coupled to the communication channel and coupled to the input line that is adapted to receive the control signal from the input line.

19. A method for monitoring and controlling at least one fiber node of a hybrid fiber-coax network where the fiber node is communicatively coupled to a head end of the hybrid fiber-coax network, the method comprising:
receiving at least one informational signal that is indicative of a condition of the fiber node at a cable modem located in the fiber node;
transmitting the informational signal from the cable modem to the head end;
evaluating the informational signal at the head-end;
transmitting at least one control signal based on the evaluation from the head end to the cable modem; and
using the control signal to alter the operation of the fiber node.

20. A method for monitoring and controlling at least one fiber node of a hybrid fiber-coax network where the fiber node is communicatively coupled to a head end of the hybrid fiber-coax network, the method comprising:
transmitting an informational signal from at least one controllable device in the fiber node that is indicative of a condition of the controllable device to a monitor-and-control circuit located in the fiber node;
transmitting the informational signal from the monitor-and-control circuit to a cable modem located in the fiber node;
transmitting the informational signal from the cable modem to a cable modem transmission system at the head end;
transmitting the informational signal from the cable modem transmission system to a monitor-and-control subsystem at the head end;
evaluating the informational signal using the monitor-and-control subsystem;
transmitting at least one control signal based on the evaluation from the monitor-and-control subsystem to the cable modem transmission system;
transmitting the control signal from the cable modem transmission system to the cable modem;
transmitting the control signal from the cable modem to the monitor-and-control circuit; and
transmitting the control signal to the controllable device to control its operation.

21. A method for identifying a problematic line out of at least two lines of a fiber node of a hybrid fiber-coax network where the fiber node is communicatively coupled to a head end of the hybrid fiber-coax network, the method comprising:
receiving a signal at the head end that is indicative of a problematic condition in one of the lines of the fiber node;
transmitting control signals from the head end to a cable modem located in the fiber node, in response to receiving the signal, that sequentially disable and enable the respective lines one at a time; and
monitoring further signals at the head end to determine the effect of disabling the respective lines on the occurrence of the problematic condition.

22. The method of claim 21, wherein receiving the signal at the head end and transmitting the control signals from the head end is accomplished using a cable modem transmission system.

23. The method of claim 22, further comprising transmitting the signal from the cable modem transmission system to a monitor-and-control subsystem and using the monitor-and-control subsystem to determine that the signal is indicative of a problematic condition in one of the lines of the fiber node.

24. The method of claim 23, wherein transmitting the control signals further comprises transmitting the control signals from the monitor-and-control subsystem to the cable modem transmission system.

25. The method of claim 21, wherein monitoring is accomplished by receiving a signal indicative of the condition of one of the lines at the monitor-and-control subsystem and using the monitor-and-control subsystem to evaluate the signal.

26. The method of claim 21 further comprising identifying the problematic line to be the line that reduces the problematic condition when disabled.

27. The method of claim 21 further comprising transmitting at least one control signal from the head end to the cable modem that reduces the problematic condition.

28. A method for identifying a problematic line out of at least two lines of a fiber node of a hybrid fiber-coax network where the fiber node is communicatively coupled to a head end of the hybrid fiber-coax network, the method comprising:
receiving a signal that is indicative of a problematic condition in one of the lines of the fiber node at a monitor-and-control subsystem located at the head end;
transmitting control signals from the monitor-and-control subsystem to a cable modem transmission system;
transmitting the control signals from the cable modem transmission system to a cable modem in the fiber node;
transmitting the control signals from the cable modem to a monitor-and-control circuit in the fiber node;
using the control signals to sequentially disable and enable the respective lines one at a time; and
monitoring further signals to determine the effect of disabling the respective lines on the occurrence of the problematic condition using the monitor-and-control subsystem.

29. The method of claim 28, wherein receiving a signal further comprises using the monitor-and-control subsystem to determine that the signal is indicative of a problematic condition in one of the lines of the fiber node.

30. The method of claim 28 further comprising identifying the problematic line to be the line that reduces the problematic condition when disabled.

31. The method of claim 28 further comprising transmitting at least one control signal from the head end to the cable modem that reduces the problematic condition.
